(19) United States
(12) Patent Application Publication
(10) Pub. No.: US 2024/0362997 A1
(43) Pub. Date: Oct. 31, 2024

(54) SENSITIVITY ADJUSTMENT USING INTEGRATED PASSIVE INFRARED SENSORS

(71) Applicant: JOHNSON CONTROLS TYCO IP HOLDINGS LLP, Milwaukee, WI (US)

(72) Inventors: Jovanny GONZALEZ, Westford, MA (US); Faruk MEAH, Woking Surrey (GB); Joseph D. FARLEY, Warwick, MA (US); Stephen J. PENNEY, Feltham, Middlesex (GB); John B. STOWELL, Hollis, NH (US)

(21) Appl. No.: 18/579,190

(22) PCT Filed: Jul. 18, 2022
(86) PCT No.: PCT/US2022/073826

§ 371 Date: Jan. 12, 2024

Related U.S. Application Data
(60) Provisional application No. 63/223,440, filed on Jul. 19, 2021.

(51) Int. Cl. G08B 29/04; G01J 5/00

(52) U.S. Cl. CPC G08B 29/043; G01J 5/0025

(57) ABSTRACT

Example aspects include methods, apparatuses, and computer-readable medium for receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base; determining, by the computing device, whether the data is indicative of a change in an occupancy status of the area of the building; and adjusting, by the computing device, a sensitivity of the primary sensor responsive to the data being indicative of the change in the occupancy status of the area of the building.

### CROSS REFERENCE TO RELATED APPLICATION(S)

This application claims priority to U.S. Provisional Application Ser. No. 63/223,440, entitled “SENSITIVITY ADJUSTMENT USING INTEGRATED PASSIVE INFRARED SENSORS” and filed on Jul. 19, 2021, which is expressly incorporated by reference herein in the entirety.

### BACKGROUND

The present disclosure relates generally to building automation/security/safety systems, and more particularly, to sensor sensitivity adjustment in building automation/security/safety systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method comprising receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base. The method further comprises determining, by the computing device, whether the data is indicative of a change in an occupancy status of the area of the building. The method further comprises adjusting, by the computing device, a sensitivity of the primary sensor responsive to the data being indicative of the change in the occupancy status of the area of the building.

Another example implementation includes a system comprising a sensor base that is mountable to a ceiling in an area of a building. The system further comprises one or more occupancy detection sensors that are integratable within or mountable on the sensor base. The system further comprises a primary sensor that is integratable within or mountable on the sensor base, wherein a sensitivity of the primary sensor is adjustable responsive to data from the one or more occupancy detection sensors being indicative of a change in an occupancy status of the area of the building.

Another example implementation includes a primary sensor comprising a processor; and a memory communicatively coupled with the processor and storing instructions that are executable by the processor, wherein the primary sensor is integratable within or mountable on a sensor base, wherein one or more occupancy detection sensors are integratable within or mountable on the sensor base, wherein a sensitivity of the primary sensor is adjustable responsive to data from the one or more occupancy detection sensors being indicative of a change in an occupancy status of an area of a building.

Another example implementation includes a sensor base comprising a processor; and a memory communicatively coupled with the processor, wherein one or more occupancy detection sensors are integratable within or mountable on the sensor base, wherein a primary sensor is integratable within or mountable on the sensor base, wherein a sensitivity of the primary sensor is adjustable responsive to data from the one or more occupancy detection sensors being indicative of a change in an occupancy status of an area of a building.

Another example implementation includes a control panel comprising a processor; and a memory communicatively coupled with the processor, wherein the processor is configured to adjust a sensitivity of a primary sensor by: receiving data from one or more occupancy detection sensors that are mounted on or integrated within a sensor base, wherein the sensor base is mounted to a ceiling in an area of a building, wherein a primary sensor is mounted on or integrated within the sensor base; determining whether the data is indicative of a change in an occupancy status of the area of the building; and adjusting a sensitivity of the primary sensor responsive to the data being indicative of the change in the occupancy status of the area of the building.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example building automation/security/safety system for sensor sensitivity adjustment, according to aspects of the present disclosure;

FIG. 2 is a front view of an example sensor assembly in the example building automation/security/safety system of FIG. 1, according to aspects of the present disclosure;

FIG. 3A is a side view of a first example of the sensor assembly of FIG. 2, according to aspects of the present disclosure;

FIG. 3B is a side view of a second example of the sensor assembly of FIG. 2, according to aspects of the present disclosure;

FIG. 3C is a side view of a third example of the sensor assembly of FIG. 2, according to aspects of the present disclosure;

FIG. 4 is a block diagram of an example sensitivity adjustment logic table, according to aspects of the present disclosure;

FIG. 5 is a block diagram of an example computing device which may implement a component in the example building automation/security/safety system of FIG. 1, according to aspects of the present disclosure; and

FIG. 6 is a flow diagram of an example sensitivity adjustment method, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure implement one or more integrated occupancy detection sensors, such as one or more passive infrared (PIR) sensors, in a sensor base of a primary sensor and use the integrated PIR sensors to adjust the sensitivity of the primary sensor (which may be, but are not limited to, for example, a smoke detector (e.g., a photo sensor, an ionization sensor, etc.), a heat sensor, a carbon monoxide (CO) sensor, a combination sensor, etc.). In an aspect, a sensor base including the integrated PIR sensors may be configured to be mounted to a flat surface such as a ceiling in an area of a building, and the primary sensor may be configured to snap into or otherwise attach to or mount to the base. In an aspect, for example, the integrated PIR sensors may be used to monitor building occupants by detecting their motion, and data from the integrated PIR sensors may be used to change the sensitivity of the primary sensor, for example, to reduce false alarms when occupants are in a building, and/or to allow for faster fire detection when there are no occupants in a building. In an aspect, when motion is detected, the primary sensor is placed in a low sensitivity state, for example, to reduce nuisance alarms. Subsequently, if there is no motion detected for a period of time, the primary sensor resumes operating in a high sensitivity state, for example, to detect fires faster.

As compared to implementing the integrated PIR sensors within the primary sensor itself, implementing the integrated PIR sensors in the sensor base of the primary sensor allows for flexibility and ease in changing/updating the primary sensor (e.g., changing a primary sensor model/type) while maintaining the use of the integrated PIR sensors in the sensor base for sensitivity adjustment and/or any other functionality. Additionally, as compared to implementing the integrated PIR sensors within the primary sensor itself, implementing the integrated PIR sensors in the sensor base of the primary sensor reduces the number of models/stock-keeping units (SKUs) of the primary sensor and reduces the production cost and complexity of the primary sensor. In an aspect, for example, mounting the integrated PIR sensors to the sensor base according to the present aspects allows the sensor base to provide the utility of the integrated PIR sensor to a variety of models and detectors mounted thereon (e.g., a heat sensor, a combination smoke and heat detector (e.g., a combination photo and heat sensor, a combination ionization and heat sensor, etc.), a combination smoke and heat and CO detector (e.g., a combination photo and heat and CO sensor, a combination ionization and heat and CO sensor, etc.), etc.).

In an optional aspect, more than one integrated PIR sensors may be mounted to a sensor base for providing better motion detection coverage, for example, in cases where the sensor base is mounted to a ceiling or other structure at a height that limits the field of view of the PIR sensors.

In an optional aspect, instead of or in addition to adjusting sensor sensitivity based on a selected time interval (e.g., low sensitivity from 7:00 am to 4:00 pm and high sensitivity otherwise), the present aspects adjust sensor sensitivity automatically by using the integrated PIR sensors in the sensor base of a primary sensor. Accordingly, the present aspects alleviate the need for manually adjusting the sensitivity of the primary sensor.

In an optional aspect, the data from the integrated PIR sensors may alternatively or additionally be used in a building management/security system, a lighting control system, etc.

In an optional aspect, for example, the data from the integrated PIR sensors may alternatively or additionally be used for reducing the sound pressure level for sounders when people are nearby (e.g., to save current, to reduce excess noise, etc.).

In an optional aspect, the data from the integrated PIR sensors may alternatively or additionally be used for fire detection.

In alternative or additional aspects, a separate PIR sensor may be used in addition to the integrated PIR sensors to monitor occupancy in the building and adjust the sensitivity of the primary sensor accordingly.

In alternative or additional aspects, an access control system may be used in addition to the integrated PIR sensors to monitor occupancy in the building and adjust the sensitivity of the primary sensor accordingly.

In alternative or additional aspects, interconnections with a lighting system (e.g., manual light switches, automatic light switches, etc.) may be used to monitor the lighting system status (e.g., to determine whether one or more lights are turned on or off by an occupant), and such interconnections may be used in addition to the integrated PIR sensors to monitor occupancy in the building and adjust the sensitivity of the primary sensor accordingly.

In alternative or additional aspects, interconnections with a manual or virtual punch clock and/or access control system may be used to monitor activity of workers in an area in a building (e.g., whether one or more workers have entered or exited an area in a building), and such interconnections may be used in addition to the integrated PIR sensors to monitor occupancy in the building and adjust the sensitivity of the primary sensor accordingly.

Turning now to the figures, example aspects are depicted with reference to one or more components described herein, where components in dashed lines may be optional.

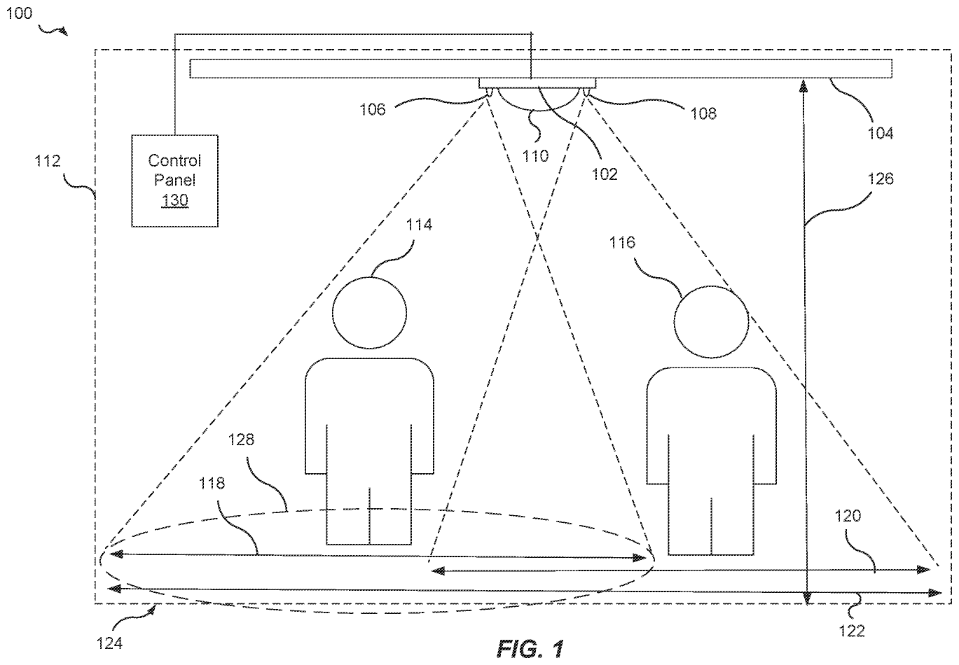

Referring to FIG. 1, in one non-limiting aspect, a sensor base 102 is mounted onto a ceiling 104 in an area 112 of a building 100, and the sensor base 102 includes one or more occupancy detection sensors mounted thereon, such as a first PIR sensor 106 having a first field of view 118 and a second PIR sensor 108 having a second field of view 120. The PIR sensors 106 and 108 are used to detect motion (e.g., walking) of building occupants (e.g., individuals 114, 116). A primary sensor 110 is also mounted onto the sensor base 102, and the PIR sensors 106 and 108 may be optionally employed to adjust detector modes/sensitivities of the primary sensor 110. In some aspects, such mode/sensitivity adjustment may be implemented instead of or in addition to a day/night mode of the primary sensor 110.

In one non-limiting implementation, when mounted on a 9-foot ceiling 104, for example, each one of the PIR sensors 106 and 108 may detect motion within a minimum 10-foot radius. That is, the field of view 118 of the PIR sensor 106 and the field of view 120 of the PIR sensor 108 may each have a minimum 10-foot radius on a floor 124 of the area 112. However, using both of the PIR sensors 106 and 108 for occupancy detection may provide a combined field of view 122 with a lager radius (e.g., 15 feet), depending on an overlap between the respective fields of view.

Although two PIR sensors 106, 108 are illustrated in FIG. 1, the present aspects are not so limited, and any number of PIR sensors (e.g., 3, 4, etc.) may be implemented in the sensor base 102 of the primary sensor 110, for example, to provide better motion detection coverage.

In one non-limiting implementation, each one of the PIR sensors 106 and 108 includes a local microcontroller that is configured to communicate with the primary sensor 110, for example, through a simple transistor-transistor-logic (TTL)—level half-duplex serial protocol.

In one non-limiting implementation, a control panel 130 is communicatively coupled with the sensor base 102 and is configured to poll the primary sensor 110 periodically for information regarding the PIR sensors 106 and 108 to select the sensitivity of the primary sensor 110 accordingly.

In one non-limiting implementation, the control panel 130 may send commands to the primary sensor 110 to change features of the PIR sensors 106 and 108 such as a timer, sensitivity, etc.

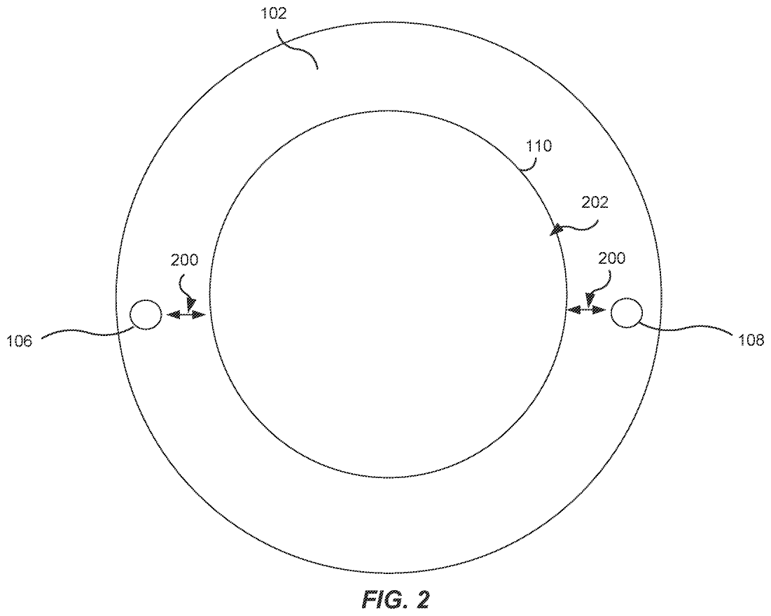

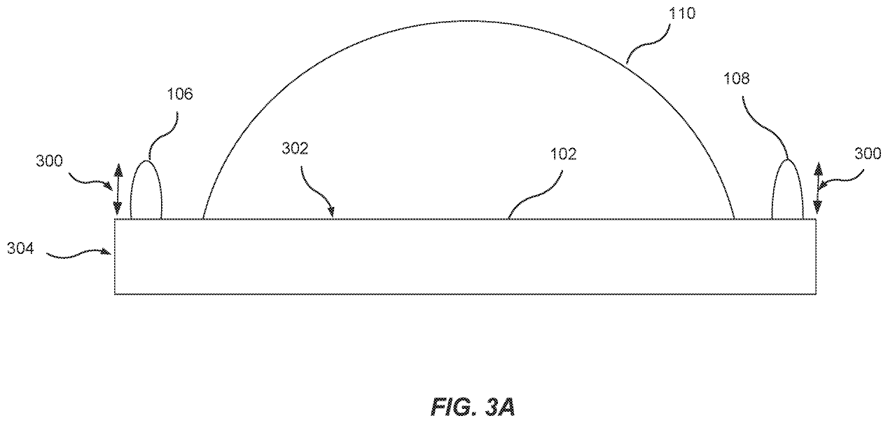

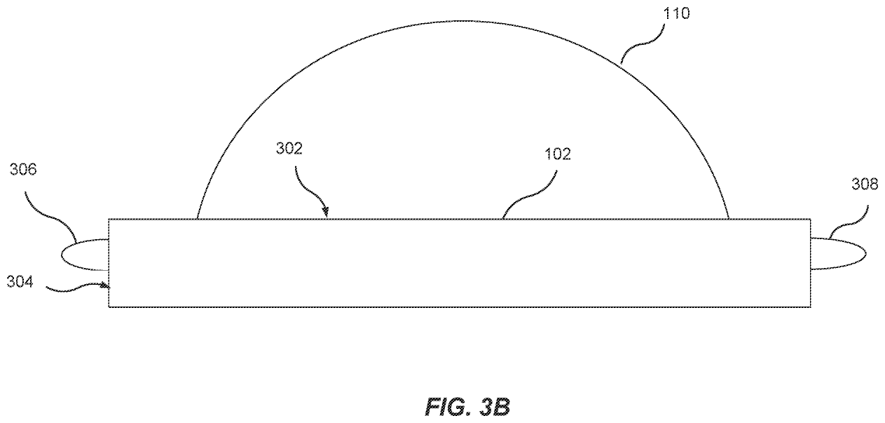

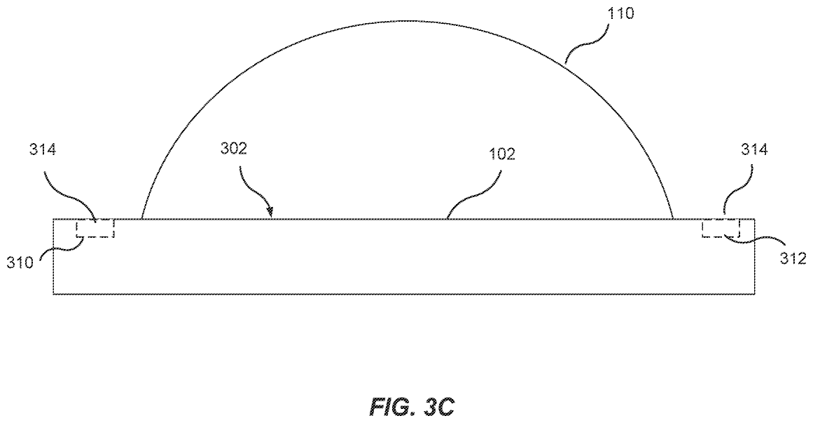

Referring also to FIGS. 2 and 3A, in order to prevent the field of view of the PIR sensors 106, 108 from being obstructed by the primary sensor 110, each one of the PIR sensors 106, 108 is mounted at a distance 200 from a housing 202 of the primary sensor 110 and is elevated by a height 300 with respect to a surface 302 of the sensor base 102. The field of views 118, 120 of the PIR sensors 106, 108 is affected by the distance 200 between the PIR sensors 106 and 108 and the housing 202 of the primary sensor 110. The field of views 118, 120 of the PIR sensors 106, 108 is also affected by the height 126 of the ceiling 104 on which the sensor base 102 is mounted. The bigger the distance 200 between the PIR sensors 106, 108 and the housing 202 of the primary sensor 110, the wider the field of views 118, 120 of the PIR sensors 106, 108. Also, the higher the ceiling 104 on which the sensor base 102 is mounted, the wider the field of views 118, 120 of the PIR sensors 106, 108. Additionally, when there are more than one PIR sensors 106, 108 mounted on the sensor base 102, a combined field of view 122 is achieved which includes any area covered by the field of views 118, 120 of any of the PIR sensors 106, 108.

In an aspect, the PIR sensors 106, 108 are situated/positioned such that operation of the primary sensor 110 is not impeded by the location/proximity of the PIR sensor 106, 108 with respect to the primary sensor 110. For example, in a case where the primary sensor 110 is a smoke detector, the PIR sensors 106, 108 are situated/positioned such that a flow of air, particulates, etc., through the primary sensor 110 is not interrupted/impeded by the PIR sensors 106, 108.

Although in the example aspect in FIG. 3A, the PIR sensors 106, 108 are mounted vertically on the sensor base 102 and are elevated by the height 300 with respect to the surface 302 of the sensor base 102, the present aspects are not so limited, and one or more alternative or additional PIR sensors may be mounted to or implemented within the sensor base 102 with different orientations, locations, arrangements, etc.

For example, referring to FIG. 3B, in some alternative or additional non-limiting aspects, one or more alternative or additional PIR sensors 306, 308 may be mounted horizontally to an edge 304 of the sensor base 102 (e.g., protruding horizontally out of the edge 304 of the sensor base 102). The PIR sensors 306, 308 may provide the same or similar functionality as described herein with reference to the PIR sensors 106, 108.

In some other alternative or additional non-limiting aspects, referring to FIG. 3C, one or more alternative or additional PIR sensors 310, 312 may be embedded within the sensor base 102 so that the PIR sensors 310, 312 do not protrude out of the sensor base 102 (e.g., do not stick out of the surface 302 of the sensor base 102, are not elevated with respect to the surface 302 of the sensor base 102, etc.). In these aspects, the PIR sensors 310, 312 may have a transparent window 314 in the sensor base 102 so that the PIR sensors 310, 312 can “see” outside the sensor base 102. The PIR sensors 310, 312 may provide the same or similar functionality as described herein with reference to the PIR sensors 106, 108.

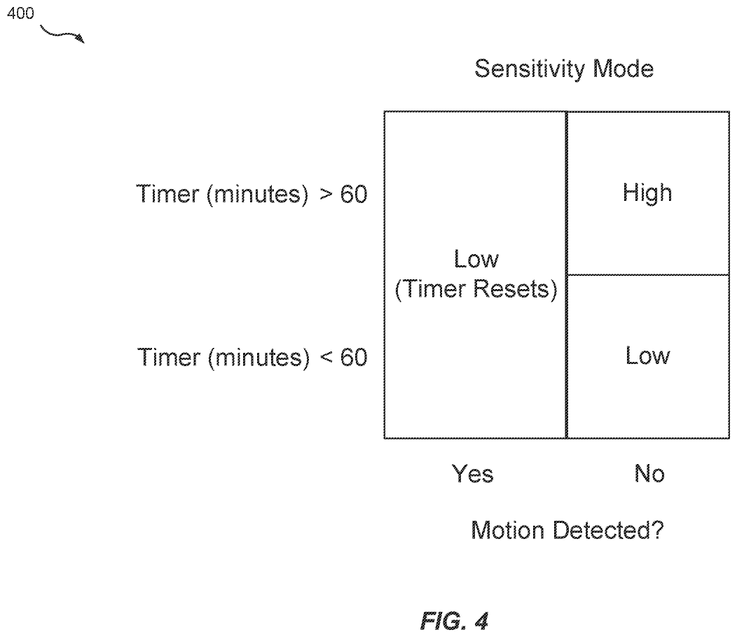

Referring to FIG. 4, in one non-limiting aspect, the sensitivity of the primary sensor 110 may be adjusted according to a logic table 400. For example, expiration of a 60-minute timer may indicate when the primary sensor 110 may switch sensitivities. If no motion is detected after 60 minutes, the primary sensor 110 switches to a “High” sensitivity mode and stays in this mode until motion is detected. When motion is detected, the primary sensor 110 switches to a “Low” sensitivity mode and the 60-minute timer is reset. The primary sensor 110 stays in this mode as long as the 60-minute timer does not expire.

In an aspect, the PIR sensors 106, 108, 306, 308, 310, 312 in the sensor base 102 are used for adjusting the sensitivity of only the primary sensor 110 mounted to that sensor base 102. In an alternative or additional aspect, the PIR sensors 106, 108, 306, 308, 310, 312 may be used for adjusting the sensitivity of one or more other sensors in a vicinity of the sensor base 102. For example, in an aspect, the control panel 130 may use the data (e.g., motion detected/no motion detected) provided by the PIR sensors 106, 108, 306, 308, 310, 312 in the sensor base 102 to adjust the sensitivity of one or more other sensors in a zone. However, using the PIR sensors 106, 108, 306, 308, 310, 312 in the sensor base 102 for adjusting the sensitivity of only the primary sensor 110 that is mounted to the sensor base 102 provides better granularity/precision in controlling/adjusting sensor sensitivity based on occupancy detected in a vicinity of the primary sensor 110 (e.g., within a 10 foot or 20 foot boundary of the primary sensor 110, where the boundary is defined by the combined field of view 122 of the PIR sensors 106, 108, 306, 308, 310, 312 in the sensor base 102 of the primary sensor 110), as opposed to occupancy detected farther away from the primary sensor 110 (e.g., 50 feet away from the primary sensor 110).

In an aspect, data (e.g., motion detected/no motion detected) from the PIR sensors 106, 108, 306, 308, 310, 312 in the sensor base 102 is used for selecting the sensitivity of the primary sensor 110 from at least two different sensitivity levels/states, which may include a high sensitivity state and a low sensitivity state. In one optional implementation, the sensitivity of the primary sensor 110 may be selected from at least three different sensitivity levels/states, which may include a high sensitivity state, a low sensitivity state, and a hush state.

In an aspect, a first protocol is implemented for communication between the primary sensor 110 and the control panel 130, and a different second protocol is implemented for communication between the primary sensor 110 and the PIR sensors 106, 108, 306, 308, 310, 312. In one example implementation, the first protocol may be the “MX” protocol developed by Thorn Security Ltd. The MX protocol may be used by the control panel 130 for communicating with and providing power to all devices on a wiring loop, including devices mounted onto the sensor base 102. The MX protocol is a 2-way, 3 or 4 kilobit, high voltage signaling line protocol configured for operating at 20V to 40V. In contrast, the second protocol is a less complex and lower voltage protocol that is used to communicate between the primary sensor 110 and the PIR sensors 106, 108, 306, 308, 310, 312 but not for providing power to the PIR sensors 106, 108, 306, 308, 310, 312. For example, the second protocol may be a 2-way, one bit, low voltage protocol configured for operating at 0V to 3.3V. In one example implementation, the second protocol may be a simple TTL-level half-duplex protocol.

In some implementation, each one of the PIR sensors 106, 108, 306, 308, 310, 312 is a modular component that is pluggable into the sensor base 102.

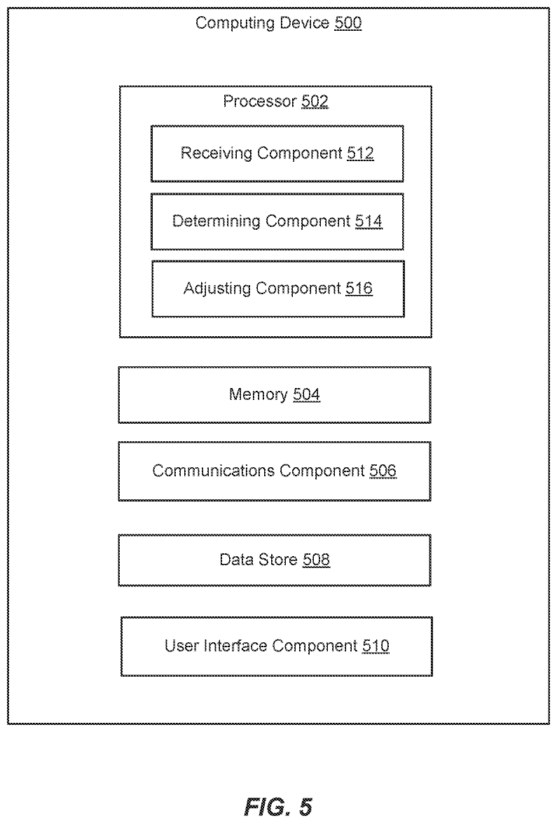

FIG. 5 illustrates an example block diagram providing details of computing components in a computing device 500 that may implement all or a portion of the sensor base 102, the primary sensor 110, the PIR sensors 106, 108, 306, 308, 310, 312, the control panel 130, or any other component described with reference to FIGS. 1, 2, 3A-3C, and 4 above. The computing device 500 includes a processor 502 which may be configured to execute or implement software, hardware, and/or firmware modules that perform any functionality described herein with reference to the sensor base 102, the PIR sensors 106, 108, 306, 308, 310, 312, the primary sensor 110, the control panel 130, or any other component described with reference to FIGS. 1, 2, 3A-3C, and 4 above.

The processor 502 may be a micro-controller and/or may include a single or multiple set of processors or multi-core processors. Moreover, the processor 502 may be implemented as an integrated processing system and/or a distributed processing system. The computing device 500 may further include a memory 504, such as for storing local versions of applications being executed by the processor 502, related instructions, parameters, etc. The memory 504 may include a type of memory usable by a computer, such as random access memory (RAM), read only memory (ROM), tapes, magnetic discs, optical discs, volatile memory, non-volatile memory, and any combination thereof. Additionally, the processor 502 and the memory 504 may include and execute an operating system executing on the processor 502, one or more applications, display drivers, etc., and/or other components of the computing device 500.

Further, the computing device 500 may include a communications component 506 that provides for establishing and maintaining communications with one or more other devices, parties, entities, etc. utilizing hardware, software, and services. The communications component 506 may carry communications between components on the computing device 500, as well as between the computing device 500 and external devices, such as devices located across a communications network and/or devices serially or locally connected to the computing device 500. For example, the communications component 506 may include one or more buses, and may further include transmit chain components and receive chain components associated with a wireless or wired transmitter and receiver, respectively, operable for interfacing with external devices.

Additionally, the computing device 500 may include a data store 508, which can be any suitable combination of hardware and/or software, that provides for mass storage of information, databases, and programs. For example, the data store 508 may be or may include a data repository for applications and/or related parameters not currently being executed by processor 502. In addition, the data store 508 may be a data repository for an operating system, application, display driver, etc., executing on the processor 502, and/or one or more other components of the computing device 500.

The computing device 500 may also include a user interface component 510 operable to receive inputs from a user of the computing device 500 and further operable to generate outputs for presentation to the user (e.g., via a display interface to a display device). The user interface component 510 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 510 may include one or more output devices, including but not limited to a display interface, a speaker, a haptic feedback mechanism, a printer, any other mechanism capable of presenting an output to a user, or any combination thereof.

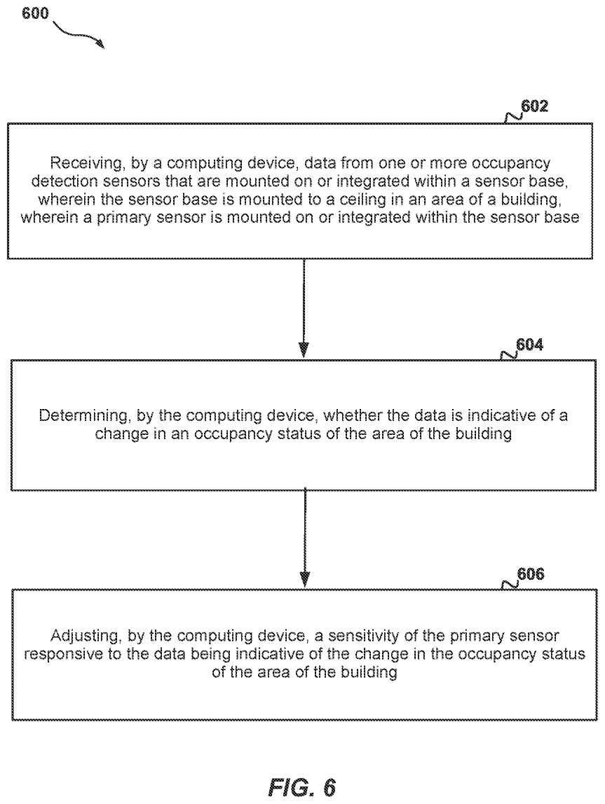

FIG. 6 is a flowchart of an example method 600 for sensitivity adjustment. The method 600 may implement the functionality described herein with reference to FIGS. 1, 2, 3A-3C, 4, and 5 above, and may be performed by one or more components of the computing device 500 and/or one or more components of the sensor base 102, the PIR sensors 106, 108, 306, 308, 310, 312, the primary sensor 110, the control panel 130, or any other component described herein with reference to FIGS. 1, 2, 3A-3C, 4, and 5 above.

At 602, the method 600 includes receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base. For example, in an aspect, the computing device 500, the sensor base 102, the PIR sensors 106, 108, 306, 308, 310, 312, the primary sensor 110, the control panel 130, and/or receiving component 512 may be configured to or may comprise means for receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base.

For example, referring to FIG. 1, in an aspect, the primary sensor 110 may receive data from one or more occupancy detection sensors such as the PIR sensors 106, 108 that are integrated within and/or otherwise mounted to the sensor base 102, wherein the sensor base 102 is mounted to a ceiling 104 in an area 112 of a building 100, wherein the primary sensor 110 is mounted to the sensor base 102.

At 604, the method 600 includes determining, by the computing device, whether the data is indicative of a change in an occupancy status of the area of the building. For example, in an aspect, the computing device 500, the sensor base 102, the PIR sensors 106, 108, 306, 308, 310, 312, the primary sensor 110, the control panel 130, and/or determining component 514 may be configured to or may comprise means for determining, by the computing device, whether the data is indicative of a change in an occupancy status of the area of the building.

For example, referring to FIG. 1, a microcontroller in the primary sensor 110 may determine whether the data from the PIR sensors 106, 108 is indicative of a change in an occupancy status of the area 112 of the building 100. For example, the PIR sensors 106, 108 may be configured to send data to the primary sensor 110 in response to detecting a motion in the area 112, and/or may be configured to periodically send data to the primary sensor 110 indicating whether or not motion has been detected in the area 112. In an aspect, if the occupancy status of the area 112 was previously identified as unoccupied, and subsequently the first PIR sensor 106 detects a motion of a first individual 114 and sends corresponding data to the primary sensor 110, and/or the second PIR sensor 108 detects a motion of a second individual 116 and sends corresponding data to the primary sensor 110, the microcontroller in the primary sensor 110 may determine that the occupancy status of the area 112 has changed from unoccupied to occupied. As another example, if the occupancy status of the area 112 was previously identified as occupied, and subsequently neither one of the first PIR sensor 106 or the second PIR sensor 108 detects a motion in the area 112 for a period of time, the microcontroller in the primary sensor 110 may determine that the occupancy status of the area 112 has changed from occupied to unoccupied. In some other aspects, the primary sensor 110 may send the data of the PIR sensors 106, 108 to the control panel 130, and the control panel 130 may then determine whether the data from the PIR sensors 106, 108 is indicative of a change in an occupancy status of the area 112 of the building 100 (e.g., from unoccupied to occupied or vice versa).

At 606, the method 600 includes adjusting, by the computing device, a sensitivity of the primary sensor responsive to the data being indicative of the change in the occupancy status of the area of the building. For example, in an aspect, the computing device 500, the sensor base 102, the PIR sensors 106, 108, 306, 308, 310, 312, the primary sensor 110, the control panel 130, and/or adjusting component 516 may be configured to or may comprise means for adjusting, by the computing device, a sensitivity of the primary sensor responsive to the data being indicative of the change in the occupancy status of the area of the building.

For example, referring to FIG. 1, in an aspect, responsive to the occupancy status of the area 112 changing from occupied to unoccupied as indicated by data from the PIR sensors 106, 108, the control panel 130 may send a message to the primary sensor 110 to increase the sensitivity of the primary sensor 110. In another example, responsive to the occupancy status of the area 112 changing from unoccupied to occupied as indicated by data from the PIR sensors 106, 108, the control panel 130 may send a message to the primary sensor 110 to decrease the sensitivity of the primary sensor 110. In an alternative or additional aspect, a microcontroller in the primary sensor 110 may adjust the sensitivity of the primary sensor 110 responsive to a change in the occupancy status of the area 112 as indicated by data from at least one of the PIR sensors 106, 108.

In one non-limiting implementation, the first PIR sensor 106 has a field of view 118 that is defined at least partially by a height 126 of the ceiling 104 and a distance 200 on the sensor base 102 between the first PIR sensor 106 and a housing 202 of the primary sensor 110. Similarly, the second PIR sensor 108 has a field of view 120 that is defined at least partially by a height 126 of the ceiling 104 and a distance 200 on the sensor base 102 between the second PIR sensor 108 and a housing 202 of the primary sensor 110.

In one non-limiting implementation, the distance 200 on the sensor base 102 between the first PIR sensor 106 and the housing 202 of the primary sensor 110 is configured to cause the first field of view 118 of the first PIR sensor 106 to cover at least a boundary area 128 within the area 112 of the building 100. The second PIR sensor 108 may be configured similarly.

In one non-limiting implementation, the boundary area 128 has a radius of at least 10 feet on a floor 124 of the area 112 of the building 100.

In one non-limiting implementation, the primary sensor 110 is configured to communicate with a control panel 130 according to a first protocol (which may be the MX protocol), and each one of the PIR sensors 106, 108 is configured to communicate with the primary sensor 110 according to a second protocol (which may be a simple TT-level half-duplex protocol) that is different than the first protocol.

In one non-limiting implementation, the first protocol has a higher voltage than the second protocol.

In one non-limiting implementation, the first protocol defines a larger packet size than the second protocol.

In one non-limiting implementation, the receiving at block 602 of method 600 may include receiving the data by the primary sensor 110 from the PIR sensors 106, 108 according to the second protocol.

In one non-limiting implementation, the adjusting at block 606 of method 600 may include adjusting the sensitivity of the primary sensor 110 by a microcontroller in the primary sensor 110.

In one non-limiting implementation, the determining at block 604 of method 600 may include sending the data of the PIR sensors 106, 108 by the primary sensor 110 to the control panel 130 according to the first protocol.

In one non-limiting implementation, the determining at block 604 of method 600 may further include receiving a message by the primary sensor 110 from the control panel 130 according to the first protocol and responsive to the data from the PIR sensors 106, 108.

In one non-limiting implementation, the adjusting at block 606 of method 600 may include adjusting the sensitivity of the primary sensor 110 according to the message from the control panel 130.

Some further example aspects are provided below.
1. A method comprising:
receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base;
determining, by the computing device, whether the data is indicative of a change in an occupancy status of the area of the building; and
adjusting, by the computing device, a sensitivity of the primary sensor responsive to the data being indicative of the change in the occupancy status of the area of the building.
2. The method of clause 1, wherein the one or more occupancy detection sensors comprise at least one passive infrared sensor.
3. The method of clause 2, wherein the at least one passive infrared sensor has a field of view that is defined at least partially by a height of the ceiling and a distance on the sensor base between the at least one passive infrared sensor and a housing of the primary sensor.
4. The method of clause 3, wherein the distance on the sensor base between the at least one passive infrared sensor and the housing of the primary sensor is configured to cause the field of view of the at least one passive infrared sensor to cover at least a boundary area within the area of the building.
5. The method of clause 4, wherein the boundary area has a radius of at least 10 feet on a floor of the area of the building.
6. The method of any one of the above clauses, wherein the primary sensor is configured to communicate with a control panel according to a first protocol, wherein the one or more occupancy detection sensors are configured to communicate with the primary sensor according to a second protocol different than the first protocol.
7. The method of clause 6, wherein the first protocol has a higher voltage than the second protocol.
8. The method of clause 6 or 7, wherein the first protocol defines a larger packet size than the second protocol.
9. The method of any one of clauses 6 to 8, further comprising:
receiving the data by the primary sensor from the one or more occupancy detection sensors according to the second protocol.
10. The method of clause 9, wherein the adjusting comprises adjusting the sensitivity of the primary sensor by a microcontroller in the primary sensor.
11. The method of clause 9 or 10, further comprising:
sending the data by the primary sensor to the control panel according to the first protocol.
12. The method of clause 11, further comprising:
receiving a message from the control panel according to the first protocol and responsive to the data; and
adjusting the sensitivity of the primary sensor according to the message from the control panel.
13. The method of any one of the above clauses, wherein the primary sensor comprises at least one of a heat detector, a smoke detector, a carbon monoxide detector, or a combination detector.
14. A system comprising:
a sensor base that is mountable to a ceiling in an area of a building;
one or more occupancy detection sensors that are integratable within or mountable on the sensor base; and
a primary sensor that is integratable within or mountable on the sensor base, wherein a sensitivity of the primary sensor is adjustable responsive to data from the one or more occupancy detection sensors being indicative of a change in an occupancy status of the area of the building.
15. The system of clause 14, further configured to perform the method of any one of clauses 1 to 13.
16. A primary sensor comprising:
a processor; and
a memory communicatively coupled with the processor and storing instructions that are executable by the processor,
wherein the primary sensor is integratable within or mountable on a sensor base,
wherein one or more occupancy detection sensors are integratable within or mountable on the sensor base,
wherein a sensitivity of the primary sensor is adjustable responsive to data from the one or more occupancy detection sensors being indicative of a change in an occupancy status of an area of a building, according to the method of any one of clauses 1 to 13.
17. A sensor base comprising:
a processor; and
a memory communicatively coupled with the processor and storing instructions that are executable by the processor,
wherein one or more occupancy detection sensors are integratable within or mountable on the sensor base,
wherein a primary sensor is integratable within or mountable on the sensor base,
wherein a sensitivity of the primary sensor is adjustable responsive to data from the one or more occupancy detection sensors being indicative of a change in an occupancy status of an area of a building, according to the method of any one of clauses 1 to 13.
18. A control panel comprising:
a processor; and
a memory communicatively coupled with the processor and storing instructions that are executable by the processor, wherein the processor is configured to execute the instructions to adjust a sensitivity of a primary sensor according to the method of any one of clauses 1 to 13.

19. An apparatus comprising a processor; and a memory communicatively coupled with the processor and storing instructions that are executable by the processor, wherein the processor is configured to execute the instructions to perform the method of any one of clauses 1 to 13.

20. An apparatus comprising means for performing the method of any one of clauses 1 to 13.
21. A computer-readable medium storing instructions executable by a processor that, when executed, cause the processor to perform the method of any one of clauses 1 to 13.
22. The computer-readable medium of clause 21, wherein the computer-readable medium is non-transitory.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method comprising:
receiving, by a computing device, data from one or more occupancy detection sensors that are mounted on or integrated within a sensor base, wherein the sensor base is mounted to a ceiling in an area of a building, wherein a primary sensor is mounted on or integrated within the sensor base;
determining, by the computing device, whether the data is indicative of a change in an occupancy status of the area of the building; and
adjusting, by the computing device, a sensitivity of the primary sensor responsive to the data being indicative of the change in the occupancy status of the area of the building.

2. The method of claim 1, wherein the one or more occupancy detection sensors comprise at least one passive infrared sensor.

3. The method of claim 2, wherein the at least one passive infrared sensor has a field of view that is defined at least partially by a height of the ceiling and a distance on the sensor base between the at least one passive infrared sensor and a housing of the primary sensor.

4. The method of claim 3, wherein the distance on the sensor base between the at least one passive infrared sensor and the housing of the primary sensor is configured to cause the field of view of the at least one passive infrared sensor to cover at least a boundary area within the area of the building.

5. The method of claim 4, wherein the boundary area has a radius of at least 10 feet on a floor of the area of the building.

6. The method of claim 1, wherein the primary sensor is configured to communicate with a control panel according to a first protocol, wherein the one or more occupancy detection sensors are configured to communicate with the primary sensor according to a second protocol different than the first protocol.

7. The method of claim 6, wherein the first protocol has a higher voltage than the second protocol.

8. The method of claim 6, wherein the first protocol defines a larger packet size than the second protocol.

9. The method of claim 6, further comprising:
receiving the data by the primary sensor from the one or more occupancy detection sensors according to the second protocol.

10. The method of claim 9, wherein the adjusting comprises adjusting the sensitivity of the primary sensor by a microcontroller in the primary sensor.

11. The method of claim 9, further comprising:
sending the data by the primary sensor to the control panel according to the first protocol.

12. The method of claim 11, further comprising:
receiving a message from the control panel according to the first protocol and responsive to the data; and
adjusting the sensitivity of the primary sensor according to the message from the control panel.

13. The method of claim 1, wherein the primary sensor comprises at least one of a heat detector, a smoke detector, a carbon monoxide detector, or a combination detector.

14. A system comprising:
a sensor base that is mountable to a ceiling in an area of a building;
one or more occupancy detection sensors that are integratable within or mountable on the sensor base; and
a primary sensor that is integratable within or mountable on the sensor base, wherein a sensitivity of the primary sensor is adjustable responsive to data from the one or more occupancy detection sensors being indicative of a change in an occupancy status of the area of the building.

15. The system of claim 14, wherein the one or more occupancy detection sensors comprise at least one passive infrared sensor.

16. A primary sensor comprising:
a processor; and
a memory communicatively coupled with the processor and storing instructions that are executable by the processor,
wherein the primary sensor is integratable within or mountable on a sensor base,
wherein the sensor base is mountable to a ceiling in an area of a building,
wherein one or more occupancy detection sensors are integratable within or mountable on the sensor base,
wherein a sensitivity of the primary sensor is adjustable responsive to data from the one or more occupancy detection sensors being indicative of a change in an occupancy status of the area of the building.

17. A sensor base comprising:
a processor; and
a memory communicatively coupled with the processor and storing instructions that are executable by the processor,
wherein one or more occupancy detection sensors are integratable within or mountable on the sensor base,
wherein the sensor base is mountable to a ceiling in an area of a building,
wherein a primary sensor is integratable within or mountable on the sensor base,
wherein a sensitivity of the primary sensor is adjustable responsive to data from the one or more occupancy detection sensors being indicative of a change in an occupancy status of the area of the building.

18. A control panel comprising:
a processor; and
a memory communicatively coupled with the processor and storing instructions that are executable by the processor,
wherein the processor is configured to execute the instructions to adjust a sensitivity of a primary sensor,
wherein the primary sensor is integratable within or mountable on a sensor base,
wherein the sensor base is mountable to a ceiling in an area of a building,
wherein one or more occupancy detection sensors are integratable within or mountable on the sensor base,
wherein the sensitivity of the primary sensor is adjustable responsive to data from the one or more occupancy detection sensors being indicative of a change in an occupancy status of the area of the building.
